(19) United States
(12) Patent Application Publication
(10) Pub. No.: US 2011/0170953 A1
(43) Pub. Date: Jul. 14, 2011

(54) METHOD AND SYSTEM FOR REMOVING LIQUID HYDROCARBONS FROM CONTAMINATED SOIL

(76) Inventor: Charles M. Diamond, Bath, NH (US)

(21) Appl. No.: 12/975,468

(22) Filed: Dec. 22, 2010

Related U.S. Application Data
(60) Provisional application No. 61/293,607, filed on Jan. 8, 2010.

(51) Int. Cl. B09C 1/08

(52) U.S. Cl. 405/128.75

(57) ABSTRACT

A method for removing a liquid hydrocarbon from a contaminated soil that includes the steps of disposing the contaminated soil and liquid within a vessel, disposing a hydrophobic oleophyllic sorbent upon a surface of the liquid, agitating the contaminated soil for a period of time sufficient to allow substantially all of the liquid hydrocarbon within the contaminated soil to contact the liquid, float to the surface of the liquid, and be sorbed by the hydrophobic oleophyllic sorbent, and removing the sorbent, cleaned water and cleaned soil from the vessel.

### CLAIM OF PRIORITY

This application claims the benefit of priority of U.S. Provisional Patent Application Ser. No. 61/293,607, filed on Jan. 8, 2010.

### FIELD OF THE INVENTION

The present invention relates to methods for removing oil and other liquid hydrocarbons from contaminated soil.

### BACKGROUND OF THE INVENTION

Oil and other liquid hydrocarbon spills are a serious environmental problem on both land and water. They can damage entire ecosystems for generations. In-situ soil remediation of the liquid hydrocarbon saturated soil has thus far been found difficult, time consuming and impractical, and for this reason the contaminated soil is most commonly removed and replaced with “clean” soil.

This method is exceedingly expensive and merely moves the problem to a different location without any actual remediation of the original problem. This may have further unanticipated environmental impacts.

As an alternative in-situ bioremediation of liquid hydrocarbon-saturated land is often found to be impractical due to the required time span of many months and often many years for what is often found to be a marginal remediation result.

U.S. Pat. No. 6,155,276, tilted “Apparatus and method for removing soil contaminants” discloses a portable ground soil remediation apparatus and method utilizing a water and biodegradeable soap mixture. This apparatus and method are said to result in a safe solution to effectively remove crude or refined oil from the soil, as well as the toxins associated with this type of contamination. The apparatus includes at least one elongated, rotatable chamber filled with the soap mixture and having internal lifting means to pick up soil and provide cleansing with the soap mixture.

Unfortunately, this apparatus and method have significant drawbacks. First, the apparatus itself must be fabricated at great expense from basic raw materials such as heavy guage plate steels that must be formed and welded into a specialized piece of machinery, which requires a significant initial investment. Second, the introduction of a soap mixture to the soil introduces an additional contaminant both to the soil and the oil that is removed therefrom. Thus, the soil itself cannot be returned in-situ fully cleansed of contaminants, and the oil removed from the soil may not be easily reprocessed and used, and the soap/oil mixture, in accordance with current environmental laws and regulations, must be disposed of as a hazardous waste at great expense.

U.S. Pat. No. 4,927,293, titled “Method and apparatus for remediating contaminated soil”, discloses a method that utilizes a conveyor which moves contaminated material, a main hopper which holds a load of contaminated material and dispenses the material onto the conveyor at a receiving location, and an auxiliary hopper adjacent the main hopper which holds a load of an sorbent material and dispenses the material onto the contaminated material as the material is moved toward a transfer location. A mixing and conveying auger rotatably mounted in the mixing chamber concurrently mixes the contaminated and sorbent material received in the mixing chamber. Spray nozzles then spray pressurized oxidizing material on the mixture of contaminated and sorbent materials and air nozzles inject air under pressure in the mixture of contaminated, sorbent and oxidizing materials to aerate the materials concurrently as the oxidizing material is sprayed thereon and the contaminated, sorbent and oxidizing materials are being mixed to produce a reaction therebetween and form reaction by-products which are said to be more environmentally acceptable than the contaminated material for discharge at the deposit location.

Unfortunately, this apparatus and method also have significant drawbacks. The integrity, quality and value of the oil removed from the soil is not conserved to retain its value as an oil. Finally, although the reaction by-products are said to be more environmentally acceptable than the contaminated material, these by products cannot be disposed of in-situ and in accordance with current environmental laws and thus need to be disposed of as a hazardous waste to be in compliance with current laws.

Therefore, there remains a need for a method of removing liquid hydrocarbons from contaminated soil that substantially cleanses the soil of liquid hydrocarbons, that does not introduce additional contaminants to the soil or to the hydrocarbon being removed therefrom, that allows the liquid hydrocarbon removed from the soil to be easily and inexpensively recycled and conserved for its value and for its reuse, through a process that does not generate any waste products that are difficult or expensive to dispose of.

### SUMMARY OF THE INVENTION

The present invention offers a highly efficient method to rapidly remove the liquid hydrocarbon from liquid hydrocarbon saturated land sufficient to restore the land to its former liquid hydrocarbon free condition prior to having been contaminated with liquid hydrocarbon.

The present invention in its most simple form or embodiment involves a composition of matter that together is combined with a process of agitation to produce the desired extraction of liquid hydrocarbon from liquid hydrocarbon laden soil.

In its most basic form, the method of the present invention includes the following steps: Liquid hydrocarbon laden soil is placed in a vessel that forms part of, or is in communication with, an agitating machine together with a liquid and an oleophyllic sorbent. The sorbent is chosen to have a lower specific gravity than the liquid, which is also referred to herein as being “lighter”, so that it remains floating. The liquid hydrocarbon laden soil has a higher specific gravity than the liquid, which is also referred to herein as being “heavier”, and sinks to the bottom of the liquid. The agitation causes the soil to release the liquid hydrocarbon into the liquid that is chosen from those liquids known to be heavier than the liquid hydrocarbon such that the liquid hydrocarbon that is released from the soil floats upward through the liquid and is captured in the oleophyllic sorbent. The oleophyllic sorbent that has captured the liquid hydrocarbon is removed, leaving soil that is substantially cleaned of the liquid hydrocarbon and the intervening liquid substantially cleaned of the liquid hydrocarbon, with the oleophyllic sorbent substantially having captured the liquid hydrocarbon.

In the preferred embodiment any form of liquid hydrocarbon contaminated soil and an effective amount of water is placed in a rotating drum, such as a cement mixer, together with a sufficient amount of oleophyllic sorbent adequate to contain the liquid hydrocarbon contaminant. The water level is set sufficiently above the liquid hydrocarbon contaminated soil to allow enough distance such that the floating oleophyllic sorbent stays above and remains above the liquid hydrocarbon contaminated soil, during the agitation process.

The oil or liquid hydrocarbon contaminated soil can be any of the class of soils including sand, clay, and/or, soil as commonly found anywhere on the earth that are contaminated with any form of oil or other liquid hydrocarbon. The liquid can be any of the class of liquids that are lighter than the soil, and heavier than both the contaminant, and the contaminant specific sorbent. Suitable liquids include such as water, antifreeze, coolant or other water-based liquids, with water being the preferred liquid.

The sorbent can be any of the class of non liquid sorbents suitable for containment of the specific contaminant such as polypropylene, peat, cellulose based sorbents, plastic based sorbents, mineral based sorbents, or animal based sorbents that are of a density lower than the soil and lower than the liquid.

This process has been tested and proven to remove the liquid hydrocarbon from the soil, capture the liquid hydrocarbon within the sorbent and produce clean soil and clean water in a brief 1-30 minute cycle with a simple agitating machine or a custom made machine designed specifically for removing liquid hydrocarbon from liquid hydrocarbon contaminated soil. A preliminary test has shown this process is capable of removing up to 99% of the liquid hydrocarbon from liquid hydrocarbon contaminated soil.

This novel and new process can be used with a series of existing agitation machines ranging from mechanical or electromagnetic vibrating agitation over the frequency range of 10 seconds per cycle to 100,000 cycles per second, from hand held mixers to large cement trucks and special custom made soil agitating mixers that in a single process remove the contaminated soil, processing the contaminated soil as it moves through the machine, ultimately depositing clean soil behind the machine while the machine moves forward in a continuous process.

An additional embodiment of this new process and associated machine is to incorporate low temperature pyrolysis to heat the liquid carbon contaminated sorbent thereby removing the carbon from the contaminated sorbent. The removed carbon can be used as a soil amendment and is often referred to as bio-char. The removed carbon can be mixed with the cleaned and substantially liquid hydrocarbon free soil to improve the agricultural yields and quality of the cleaned soil.

Therefore, it is an aspect of the invention to provide a method of removing liquid hydrocarbons from contaminated soil that substantially cleanses the soil of liquid hydrocarbons.

It is a further aspect of the invention to provide a method of removing liquid hydrocarbons from contaminated soil that does not require the use of large, complex or specialized machinery.

It is a further aspect of the invention to provide a method of removing liquid hydrocarbons from contaminated soil that does not introduce additional contaminants to the soil or to the liquid hydrocarbon being removed therefrom.

It is a further aspect of the invention to provide a method of removing liquid hydrocarbons from contaminated soil that allows the liquid hydrocarbon removed from the soil to be easily and inexpensively recycled.

It is a still further aspect of the invention to provide a method of removing liquid hydrocarbons from contaminated soil that does not generate waste products that are difficult or expensive to dispose of.

There are many advantages that will be understood from the foregoing description and it will be apparent that various changes may be made in the composition, materials employed and used, and the machinery employed, without departing from the spirit and scope of the invention or sacrificing all of its advantages.

### BRIEF DESCRIPTION OF THE DRAWINGS

FIG. 1 is a flowchart showing the steps of one embodiment of the method of the present invention.

FIG. 2A is a side view of a cement mixer type vessel and agitator used in the preferred method of the present invention.

FIG. 2A is a section view across line A-A showing the interior of the vessel in which soil, liquid and sorbent are disposed.

FIG. 3 is a cut away front view of a vibratory agitator incorporated into to a vessel in which soil, liquid and loose sorbent or sorbent containment pad are disposed.

FIG. 4 is a cut away front view showing a rotating scraper type agitator incorporated into a vessel in which soil, liquid and sorbent are disposed.

FIG. 5A is a cut away front view showing a rotating drum type sorbent and a linear scraper type agitator incorporated into a vessel into which soil and liquid are disposed.

FIG. 5B is a top view of the vessel of FIG. 5A.

FIG. 6 is a side view of a preferred embodiment of the system for remediating liquid hydrocarbon contaminated soil.

### DETAILED DESCRIPTION OF THE INVENTION

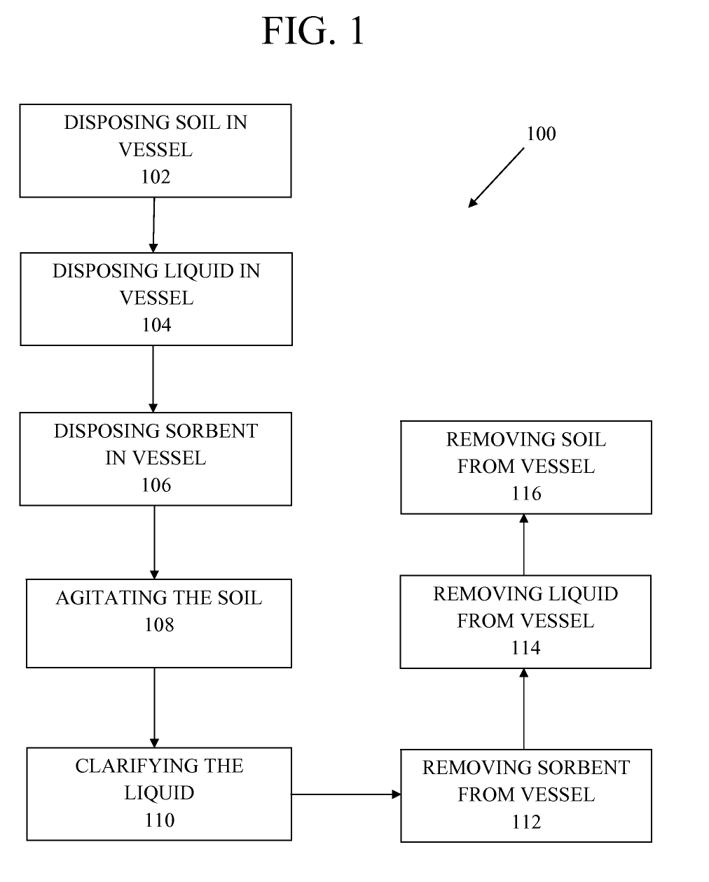

Referring first to FIG. 1, the method 100 of the present invention includes the step of disposing a quantity of soil contaminated by a liquid hydrocarbon in a vessel 102, disposing a sufficient amount of a liquid into the vessel such that it covers the soil 104 and disposing a hydrophobic oleophyllic sorbent on the surface of the liquid 106. The sorbent is described in greater detail below, but is chosen to be lighter than the liquid so that it remains floating. Accordingly, the step of disposing the sorbent upon the surface of the liquid 106 must take place after the step of disposing the liquid into the vessel 104. However, as the soil is heavier than the liquid, it will necessarily sink to the bottom of the liquid if the step of disposing the soil into the vessel 102 occurs after the step of disposing the liquid into the vessel 104. Accordingly, the order of steps 102 and 104 is not critical and these steps may be reversed.

Once steps 102, 104 and 106 are completed, the next step is the step of agitating the soil 108. Agitation causes the liquid hydrocarbon within the soil to be exposed to the liquid and, as the liquid hydrocarbon is lighter than the liquid, exposing it to the liquid causes the liquid hydrocarbon to be released from the soil and to float upward through the liquid until it contacts and is captured in the oleophyllic sorbent.

As described in detail below, the agitating step 108 may be performed by a number of different types of agitating machines, including rotating drums, vibratory agitators, compressed air agitators, electromagnetic agitators, high and low frequency sonic agitators or the like. However, regardless of what agitating means is used, for some sorbents whose sorbent properties are adversely affected by the mechanical action of being in contact with the soil it is preferred that the liquid quantity is increased sufficiently to serve as a buffer between the soil and the sorbent such that the soil itself does not come into contact with the sorbent.

The agitating step 108 is performed for a period of time that is sufficient to expose all of the liquid hydrocarbon within the soil to the liquid. This time will vary depending upon the amount of soil that is disposed within the vessel, the type and degree of compaction of the soil, and how vigorously the soil is agitated. However, testing has shown that the agitation step may be fully performed in as little as one minute using a rotating drum type agitator.

In some embodiments, the next step is to stop the agitation and allow the soil to settle to the bottom and the released liquid hydrocarbon to rise to the surface of the liquid such that the liquid is clarified. This optional step is referred to herein as clarifying the liquid 110.

The next step is removing the liquid hydrocarbon laden sorbent from the liquid 112. This step may be performed while the liquid remains in the vessel, in which case it may be performed manually using a rake, manual skimmer or other manual implement, or it may be performed mechanically, such as through the use of a vacuum or mechanically operated skimmer. However, in some embodiments, this step is performed via a screening process in which the sorbent and liquid are poured from the vessel through a screen that is sized to capture the sorbent.

In embodiments in which the step of removing the sorbent from the liquid 112 is performed while the liquid remains in the vessel, the next steps are removing the liquid from the vessel 114 and removing the cleaned soil from the vessel 116. In some embodiments, these steps are performed simultaneously by pouring the liquid and soil from the vessel through a screen that is sized to capture the soil. In other embodiments, the step of removing the liquid from the vessel 114 involves pouring or draining off the liquid until the liquid becomes cloudy with soil and then removing the remaining liquid and soil together. In still other embodiments, the step of removing the liquid from the vessel 114 is omitted and the step of removing the soil from the vessel 116 is performed by dredging the soil from the bottom of the vessel while the liquid remains in the vessel.

The method 100 of the present invention results in the soil being substantially cleaned of the liquid hydrocarbon and the intervening liquid substantially cleaned of the liquid hydrocarbon, with the oleophyllic sorbent substantially having captured substantially all of the liquid hydrocarbon that had been present in the contaminated soil.

The sorbent utilized in the method 100 can be any of the class of non liquid sorbents suitable for containment of the specific liquid hydrocarbon contaminant and include sorbents such as polypropylene, peat, cellulose based sorbents, plastic based sorbents, mineral based sorbents, or animal based sorbents that are of a density lower than the soil and lower than the liquid.

In the preferred embodiment, the sorbent is a hydrophobic oleophyllic sorbent of the type currently sold by MOP Environmental Solutions, Inc. of Bath, N.H., under the trademark “MOP”. This sorbent is described in detail in U.S. Pat. No. 5,492,881, issued on Feb. 20, 1996, which is incorporated herein by reference in its entirety.

In some embodiments, the sorbent is a hydrophobic oleophyllic sorbent having a different composition. For example, the sorbent may be manufactured from wax coated cardboard in a process that involves fiberizing the wax coated cardboard such that they are reduced in size to form a fiber particulate and such that the wax coats all exposed surfaces of the fiber particulate to form a substantially hydrophobic fiber particulate. In still other embodiments, the sorbent is manufactured from organic fibers though a process of adding a hydrophobic and oleophyllic substance, such as waxes, rosins, starches, caseins, whey, soya proteins, natural resins, synthetic resins, water-insoluble polyvinyl alcohol, hydroxyethyl cellulose, ethyl cellulose, carboxymethyl cellulose, polyethylene, polypropylene, polyacrylate, polyester and the like, to the fibers in a manner that coats all exposed surfaces of the organic fiber particulate to form a substantially hydrophobic organic fiber particulate. Regardless of how the sorbent is manufactured, the sorbent must be substantially hydrophobic and oleophyllic and must have a specific gravity that is less than the liquid.

In the preferred embodiment, the sorbent is disposed upon the surface of the liquid in a loose particulate form. However, in other embodiments, the sorbent is disposed within a liquid permeable containment, such as a pad, sock, pillow, or boom, which is dimensioned to cover substantially the entire surface of the liquid. The use of a liquid permeable containment is advantageous, as it allows the sorbent to be quickly and easily removed from the surface of the liquid. However, the use of a loose particulate sorbent is preferred due to the fact that most loose particulate sorbents will operate with a higher pickup ratio thereby requiring less sorbent and will operate more effectively to pick up liquid hydrocarbons over a wider viscosity range resulting in liquid hydrocarbon removal accomplished more thoroughly, rapidly, efficiently, and effectively.

The liquid hydrocarbon contaminated soil can be any of the class of soils including sand, clay, and/or, soil as commonly found anywhere on the earth that are contaminated with any form of oil or other liquid hydrocarbon.

The liquid can be any of the class of liquids that are lighter then the soil and heavier than both the contaminant and the contaminant specific sorbent. Suitable liquids include water, antifreeze, coolant or other water-based liquids. However, the preferred liquid is water due to its low cost, wide availability and ease of responsible disposal.

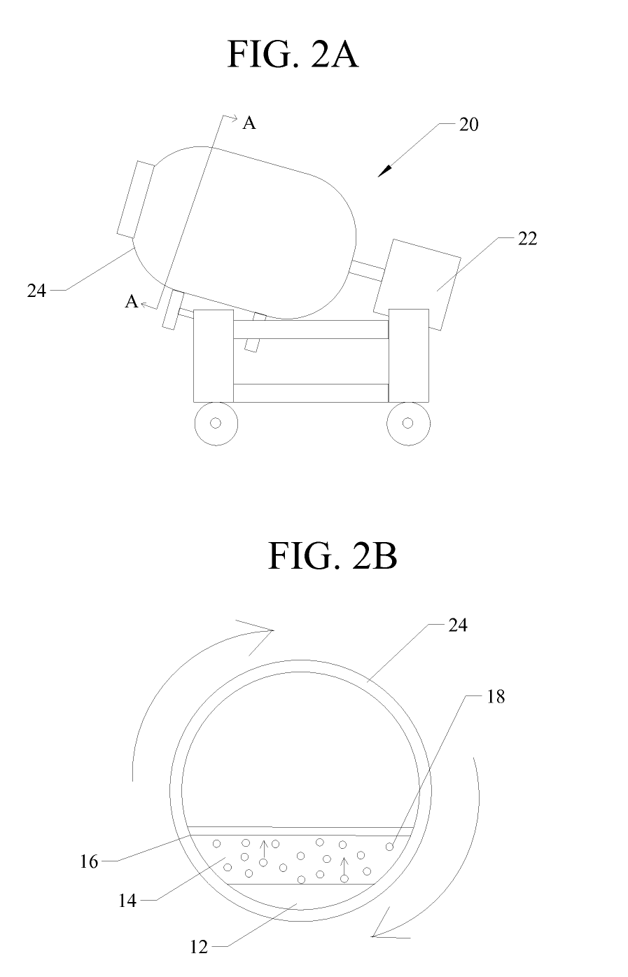

Referring now to FIGS. 2A and 2B, the preferred agitator is a rotating drum agitator 20 made up of a substantially smooth sided drum type vessel 24 and a rotator 22 for rotating the vessel. In the preferred method, the agitator is a common cement mixer drum, with or without agitating blades, paddles or ribs, ranging in size from a small portable cement mixer to that of a road going cement truck or a stationary cement plant, that is made up of a mixing vessel 24 and a mechanical rotator 22. However, in other embodiments, the vessel is a standard fifty-five gallon drum and the agitator is a portable drum rotator, such as those sold by Morse Manufacturing Co., Inc., of East Syracuse, N.Y.

As shown in FIG. 2B, contaminated soil 12 containing a liquid hydrocarbon 18 is disposed within the vessel 24. Water 14, or other suitable liquid, is disposed within the vessel 24 so as to form a layer over the soil 12. The level of the water 14 is set sufficiently above the soil 12 to allow enough distance such that the floating oleophyllic sorbent 16 stays above and remains above the soil 12, during the agitation process. The sorbent 16, preferably in loose particulate form, is disposed over the layer of water 14. The vessel 24 is then rotated, which causes the soil 12 to be agitated through tumbling. The agitation of the soil 12 causes the liquid hydrocarbon 18 disposed therein to come into contact with the water 14, which causes particles of the liquid hydrocarbon 18 to float upward. When the liquid hydrocarbon 18 reaches the surface of the water 14, it is sorbed by the sorbent 16. Once substantially all of the liquid hydrocarbon 18 is removed from the soil 12 and sorbed by the sorbent 16, the sorbent 16 is removed from the vessel 24. This step is preferably performed via a screening process in which the sorbent 16 and liquid 14 are poured from the vessel 24 through a screen (not shown) that is sized to capture the sorbent 16. However, this step may be performed while the liquid 14 remains in the vessel 24, in which case it may be performed manually using a rake, skimmer or other manual implement, or it may be performed mechanically, such as through the use of a vacuum.

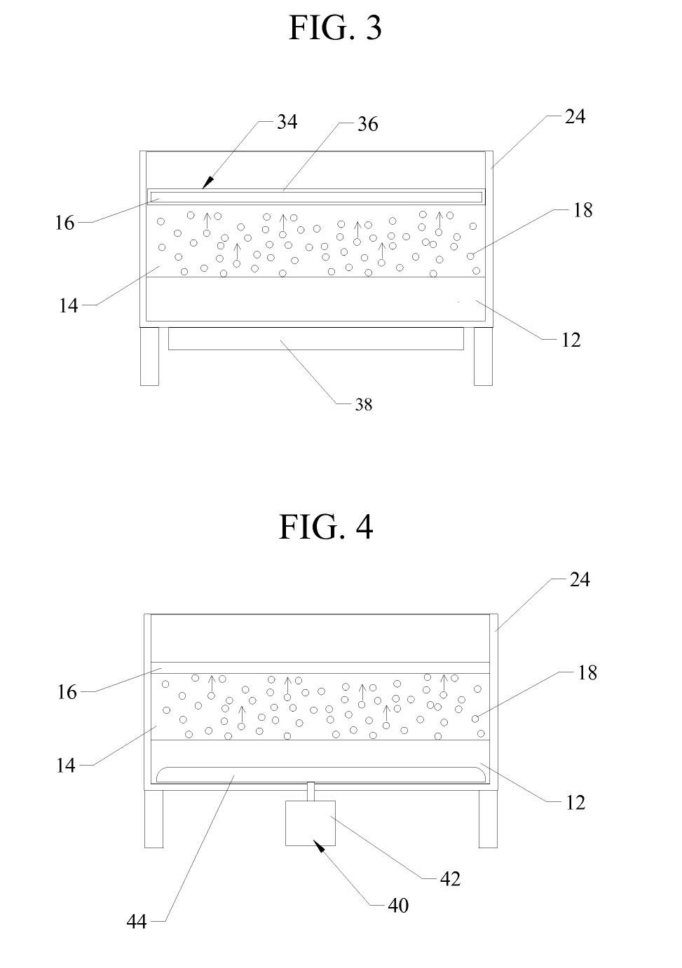

Referring now to FIG. 3, the method of the present invention may also be carried out using a vibratory agitator 38 incorporated into the vessel 24. In this embodiment, the vessel 42 may be round, rectangular or may take any other shape. A vibratory agitator 38 is disposed upon the bottom surface of the vessel 24 and electromagnetically vibrates the vessel 24 over the frequency range of 10 seconds per cycle to 100,000 cycles per second. This causes the soil 12, to be agitated, which causes the liquid hydrocarbon 18 disposed within to contact the liquid 14 and rise to the surface. In this embodiment, loose sorbent particulate or a sorbent pad 34 is disposed on the surface of the liquid 14. The loose sorbent particulate or sorbent pad 34 is entirely comprised of a sorbent material or includes a permeable outer covering 36 within which he particulate sorbent 16 is disposed. The outer covering 36 is dimensioned to correspond with the shape of the vessel 24 such that most or substantially all of the surface of the liquid is covered by the sorbent pad 34.

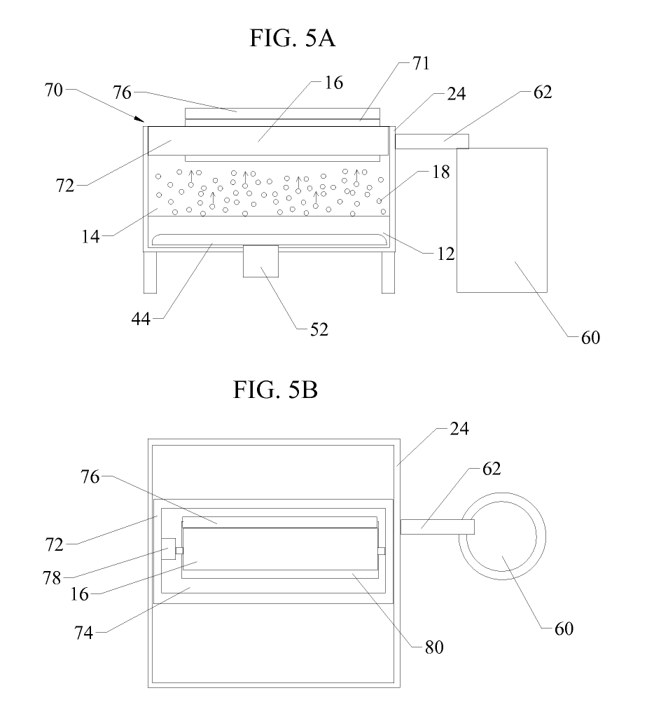

Referring now to FIG. 4, the method of the present invention may also be carried out using a scraper type agitator incorporated into to the vessel 24. In the embodiment of FIG. 4, the vessel 24 is cylindrical in shape and a scraper 44 is disposed proximate to the bottom of the vessel 24 and is connected to a source of rotation 42, such as a gas or electric motor, via a shaft 43. The source of rotation causes the scraper 44 to rotate and hence, contact the soil 12 disposed in the bottom or sides of the vessel 24. This causes the soil 12, to be agitated, which causes the liquid hydrocarbon 18 disposed within to contact the liquid 14 and rise to the surface, where it is sorbed by the sorbent 16. However, the scraper 44 need not rotate and, in embodiments such as those shown in FIGS. 5A and 5B, the scraper 44 is a liner scraper that is pushed back and forth across the bottom of the vessel 24 using a linear actuator 52. In still others, the scraper 44 is attached to a robot (not shown), which moves the scraper in random fashion along the bottom surface of the vessel.

Referring now to FIGS. 5A and 5B, in some embodiments, the sorbent 16 takes the form of a hydrophilic material, such as polyethylene, that sorbs the hydrocarbon through adsorption rather than absorption. In the embodiment of FIGS. 5A and 5B, the sorbent 16 is formed into a rotating drum that forms part of a drum style oil skimmer 70. The skimmer 79 includes the sorbent drum 16, a scraper 76 that is in contact with the sorbent drum 16, a floating housing 72 having an opening 80 through which the sorbent drum 16 extends, and a source of rotation, such as a motor 78, which causes the sorbent drum 16 to rotate.

In operation, the scraper 44 agitates the soil 12, which causes the liquid hydrocarbon 18 to float upward through the liquid 14. The rotating sorbent drum 16 contacts the liquid hydrocarbon 18 as it rises to the surface of the liquid and the liquid hydrocarbon 18 is adsorbed to the adsorbing surface of the sorbent drum 16. The sorbent drum 16 continues to rotate and the liquid hydrocarbon 18 on its adsorbing surface comes into contact with the scraper 76, which scrapes the liquid hydrocarbon 18 off of the adsorbing surface of the sorbent drum 16 and directs it into a reservoir within the floating housing 72. The liquid hydrocarbon 18 is then directed out of the housing 72, preferably through outflow pipe 62 and is captured within storage tank 60.

It is noted that embodiments that utilize adsorbent type sorbents are not limited to rotating drum apparatus. For example, in some embodiments, the sorbent takes the form of a polypropylene belt (not shown) to which the liquid hydrocarbon is adsorbed. Such a belt type system may be a custom made system, or may be a conventional oil skimming system, such as those manufactured by Abanaki Corporation of Chagrin Falls, Ohio.

The method of the present invention may also be performed by special custom made soil agitating mixers that, in a single process, remove the contaminated soil, process the contaminated soil as it moves through the machine, and ultimately deposit clean soil behind the machine while the machine moves forward in a continuous process. In embodiments in which the method is a continuous process the method includes the steps of first excavating the liquid hydrocarbon laden soil. This may be performed using conventional excavation equipment, such as with a continuous trenching machine, augur, hoe or loader, operating continuously or in batches. The next step is conveying the liquid hydrocarbon laden soil on a conveyance such as a belt, augur, screw, or chute, continuously or in batches, together with a suitable liquid such as water conveyed by hose, pipe or chute, continuously or in batches, into an agitator vessel, which is adapted to provide agitation by oscillation, rotation or vibrating motion to the mixture contained therein. A preferred agitator vessel is the agitator drum of a cement mixing truck. The next step is adding a sorbent, such as those described in detail above, to the vessel. The next step is agitating the mixture therein by oscillation, rotation or vibrating motion, continuously or in batches, such that the liquid hydrocarbon is removed from the soil by the agitation and thereby transferred to the liquid wherein it rises to the surface of the liquid and is captured by the sorbent.

Once the soil has been cleaned, the cleaned soil and liquid hydrocarbon saturated sobent are removed from the vessel. The step of removing the clean soil from the bottom of the agitating vessel may be performed continuously or in batches, and is preferably through a discharge opening identical to the entrance opening or through a separate discharge opening in a different location from the entrance opening, using a suitable flexible or solid screw augur in a solid or flexible tube, vacuum tube, pipe or enclosed conveyer such as those sold by Vibra Screw Inc., of Totowa, N.J. This allows the clean soil to be removed from the bottom of the agitator vessel continuously or in batches through a temporarily opened door or opening or through a continuous opening in the agitator vessel provided to gain access to the cleaned soil therein. The liquid hydrocarbon saturated sorbent is removed from the top of the liquid continuously or in batches with the entry point of the clean sorbent preferably at a maximum distance from the removal point of the liquid hydrocarbon saturated sorbent. This step may involve removing the sorbent by overflow of the liquid, removing the sorbent by vacuum hose or pipe or rotating screen, or by a scraper pitched at an angle across the top of the liquid to direct the liquid hydrocarbon saturated sorbent in a direction toward the discharge point where the liquid hydrocarbon saturated sorbent would be removed from on top of the liquid in the agitator vessel. Once removed from the vessel, the liquid hydrocarbon saturated sorbent is preferably stored in a tank for collection of the liquid hydrocarbon saturated sorbent.

The liquid in the agitator vessel can be continuously cleaned to minimize having to be replenished, or the liquid can be removed and renewed by withdrawal by a pipe, hose or tube from any suitable location between the soil and the floating liquid hydrocarbon saturated sorbent, continuously or in batches, and discharged to a collection tank, filtered to remove sediment and returned as a cleaned liquid to the agitator vessel, or where the liquid is water can be discharged to the ground in-situ.

The stored liquid hydrocarbon saturated sorbent can be processed to provide the fuel to propel and power any or all the functions of the soil cleaning machine. Alternatively the liquid hydrocarbon saturated sorbent can be squeezed to recover up to 99% of the liquid hydrocarbon in a screw press such as those sold by the Vincent Corporation, of Tampa, Fla. to be used as fuel or to recover the liquid hydrocarbon for it's value, with the squeezed sorbent residue retained for processing into a pellet fuel through a pellet mill such as those sold by C.P.M. of Crawfordsville, Ind. Alternatively, the squeezed sorbent or oil saturated sorbent may be subjected to low temperature pyrolysis to remove the carbon for its value as a soil amendment optionally to be saved as a separate product or to be mixed with the cleaned soil. In such embodiments, the soil and carbon are returned in-situ to boost the agricultural value of the liquid hydrocarbon cleaned soil to achieve up to a 400% higher agricultural yield than that of high quality fertilized soil while simultaneously producing a clean hydrogen based fuel from equipment such as those sold by Biochar Engineering Corporation of Golden, Colo.

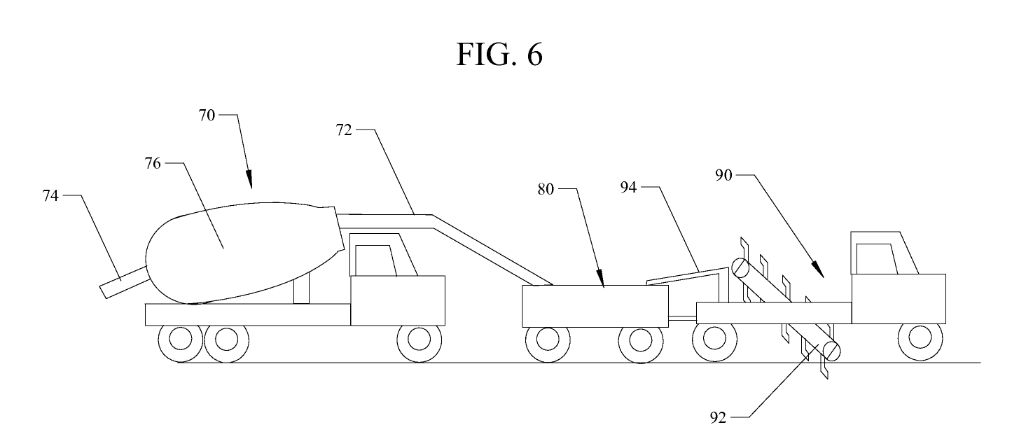

Referring now to FIG. 6, a preferred system for remediating liquid hydrocarbon contaminated soil is shown. The preferred system includes an excavator 90, which is preferably a trenching machine that includes a trenching attachment 92 for excavating the soil. The excavated soil is transferred to a holding bin 80, preferably though the use of a conveyor or other conventional soil transfer apparatus. The holding bin 80 is preferably attached to the trenching machine 90 so that it travels at the same speed thereof. The contaminated soil that is held in holding bin 80 is transferred to a cement mixing truck 70, preferably via a flexible screw augur 72 that passes through the sorbent and the surface of the liquid and deposits the soil in the bottom of the vessel 76 of the cement mixing truck 70. The rotation of the vessel 76 causes the liquid hydrocarbon to be removed from the soil and the cleaned soil is then preferably removed though a second screw auger 74 disposed through the rear of the vessel 76. This soil may either be returned directly to the excavation site or may be stored in another bin (not shown).

The preferred system allows all of these steps of the method to be combined in a continuous process wherein all of the material components typically, such as soil, oil, water and sorbent, are cleaned, separated, conserved and retained for their value. In the simplest embodiment the liquid hydrocarbon contaminated soil is excavated, cleaned and returned in minutes in-situ while the liquid, if it is water is cleaned and optionally returned in-situ or conserved for reuse in its role as the liquid used as the medium in which the liquid hydrocarbon is released from the soil to rise to the surface of the liquid where the oleophyllic and hydrophobic sorbent captures the oil. As noted above, the liquid hydrocarbon saturated sorbent can be squeezed to provide the fuel to both propel and power the soil cleaning machine and optionally through subjecting the liquid hydrocarbon saturated sorbent to low temperature pyrolysis, the carbon is removed and added to the clean soil as bio-char for its benefits as a soil amendment that can boost agricultural yields up to 400% over otherwise fertilized soil.

Regardless of which embodiment of the method is utilized to remove the liquid hydrocarbon from the soil, the method results in a substantially cleaned soil and a sorbent that contains the liquid hydrocarbon that had formerly been present in the soil. As the soil is substantially free from contaminants, an additional step in the method may be to return the soil to its original location. The method may also include steps for removing the liquid hydrocarbon from the sorbent and/or utilizing the liquid hydrocarbon laden sorbent for other purposes.

In some embodiments of the method, the liquid hydrocarbon laden sorbent is compressed such that the majority of the liquid hydrocarbon captured therein is removed from the sorbent. In embodiments in which the liquid hydrocarbon is oil, the removed oil may then be filtered and reused and may also be subjected to additional chemical processes, such as refining through distillation or other methods. In such embodiments where the sorbent is the sorbent described in U.S. Pat. No. 5,492,881, the pressed sorbent may then be exposed to the elements, which allows the outer coating thereof to degrade, which allows the entrained oil to be consumed by bacteria present in the sorbent. In others, the liquid hydrocarbon laden sorbent is used as a fuel to provide heat and/or generate steam that is then used to produce electricity. In such embodiments, the liquid hydrocarbon laden sorbent is preferably compressed into pellet form before it is burned.

In one preferred embodiment of the method, the liquid hydrocarbon laden sorbent is subjected to low temperature pyrolysis to heat the liquid carbon contaminated sorbent thereby removing the carbon from the contaminated sorbent. This is preferably accomplished using commercially available machines, such as Modular Bio-solids Optimization Platform manufactured by TSTO of Albany, Ga., or the Concord Blue System manufactured by Concord Blue Energy Company of Düsseldorf, Germany. The removed carbon can be used as a soil amendment and is often referred to as bio-char. The removed carbon can be mixed with the cleaned and substantially liquid hydrocarbon free soil to improve the agricultural yields and quality of the cleaned soil.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method for removing a liquid hydrocarbon from a contaminated soil comprising the steps of:
disposing the contaminated soil within a vessel;
disposing a quantity of liquid within the vessel, said liquid having a specific gravity that is greater than a specific gravity of the liquid hydrocarbon and less than a specific gravity of the soil;
disposing a hydrophobic oleophyllic sorbent upon a surface of the liquid;
agitating the contaminated soil for a period of time sufficient to allow substantially all of the liquid hydrocarbon within the contaminated soil to contact the liquid, float to the surface of the liquid, and be sorbed by the hydrophobic oleophyllic sorbent, and such that the contaminated soil becomes cleaned soil;
removing the hydrophobic oleophyllic sorbent within which the liquid hydrocarbon is sorbed from the vessel; and
removing the cleaned soil from the vessel.

2. The method as claimed in claim 1 further comprising the step of removing the liquid from the vessel, wherein said step of removing the liquid from the vessel is performed after the step of agitating the contaminated soil.

3. The method as claimed in claim 2 wherein said steps of removing the hydrophobic oleophyllic sorbent within which the liquid hydrocarbon is sorbed and removing the liquid from the vessel are performed substantially contemporaneously and wherein said method further comprises the step of filtering the hydrophobic oleophyllic sorbent within which the liquid hydrocarbon is sorbed from the liquid.

4. The method as claimed in claim 2 wherein said step of removing the hydrophobic oleophyllic sorbent within which the liquid hydrocarbon is sorbed from the vessel is performed before the step of removing the liquid from the vessel.

5. The method as claimed in claim 4 wherein said step of removing the hydrophobic oleophyllic sorbent within which the liquid hydrocarbon is sorbed from the vessel comprises the step of manually removing the hydrophobic oleophyllic sorbent within which the liquid hydrocarbon is sorbed.

6. The method as claimed in claim 4 wherein said step of removing the hydrophobic oleophyllic sorbent within which the liquid hydrocarbon is sorbed from the vessel comprises the step of mechanically removing the hydrophobic oleophyllic sorbent within which the liquid hydrocarbon is sorbed.

7. The method as claimed in claim 1 wherein said step of disposing a hydrophobic oleophyllic sorbent upon the surface of the liquid comprises the step of disposing a liquid permeable containment within which the hydrophobic oleophyllic sorbent is contained upon the surface of the liquid.

8. The method as claimed in claim 1 wherein the vessel is a rotatable vessel and wherein said step of agitating the contaminated soil comprises the step of rotating the vessel.

9. The method as claimed in claim 1 wherein a vibratory agitator is in vibratory communication with the contaminated soil and wherein said step of agitating the contaminated soil comprises the step of vibrating the contaminated soil.

10. The method as claimed in claim 1 wherein a scraper is disposed proximate to a bottom surface of the vessel, and wherein said step of agitating the contaminated soil comprises the step of moving the scraper along the bottom surface of the vessel.

11. The method as claimed in claim 1 further comprising the step of clarifying the liquid.

12. The method as claimed in claim 1 wherein said sorbent is an adsorbing type sorbent comprising at least one adsorbing surface and wherein said method further comprises the steps of scraping said liquid hydrocarbon from said absorbing surface of said sorbent.

13. The method as claimed in claim 12 wherein said adsorbing type sorbent is a polypropylene drum sorbent and wherein said method further comprises the step of rotating said polypropylene drum sorbent.

14. The method as claimed in claim 1 further comprising the step of removing at least a portion of the liquid hydrocarbon from the hydrophobic oleophyllic sorbent within which the liquid hydrocarbon is sorbed.

15. The method as claimed in claim 1 further comprising the step of subjecting the hydrophobic oleophyllic sorbent within which the liquid hydrocarbon is sorbed to a low temperature pyrolysis process that produces a biochar.

16. The method as claimed in claim 14 further comprising the step of mixing the biochar and the cleaned soil together.

17. The method as claimed in claim 1 further comprising the steps of excavating contaminated soil from an excavation site and returning cleaned soil to the excavation site.

18. A system for remediating contaminated soil, said system comprising:
a soil excavator;
an agitating vessel;
a source of liquid;
a source of sorbent;
means for transferring contaminated soil from said soil excavator into said agitating vessel;
means for removing cleaned soil from said agitating vessel; and
means for removing contaminated sorbent from said agitating vessel.

19. The system as claimed in claim 18 wherein said agitating vessel is a cement mixing truck.

20. The system as claimed in claim 18 wherein at least one of said means means for transferring contaminated soil from said soil excavator into said agitating vessel and said means for removing cleaned soil from said agitating vessel is a screw augur.
